(19) United States
(12) Patent Application Publication
(10) Pub. No.: US 2008/0137650 A1
(43) Pub. Date: Jun. 12, 2008

(54) CONVERSION OF DTMF CARRYING IP PACKETS

(76) Inventors: Parameswaran Kumarasamy, San Jose, CA (US); Kan Wu, Milpitas, CA (US); Paul R.P. Chu, Saratoga, CA (US); Jayesh Chokshi, Cupertino, CA (US)

Correspondence Address: SCHWEGMAN, LUNDBERG & WOESSNER, P.A., P.O. BOX 2938, MINNEAPOLIS, MN, 55402, US

(21) Appl. No.: 11/609,240

(22) Filed: Dec. 11, 2006

(51) Int. Cl. H04L 12/66

(52) U.S. Cl. 370/356

(57) ABSTRACT

A method and apparatus is described to convert DTMF packets at a network node in an IP network. The method may comprise receiving an Internet Protocol (IP) packet at the network node connected via a first IP network link to a first network device, and connected via a second IP network link to a second network device. The method may determine a first DTMF packet format for the first IP network link and a second DTMF packet format for the second IP network link and detect that only one of the first or second DTMF packet formats is in-band voice DTMF. Thereafter, the method may convert the received IP packet from the first DTMF packet format to the second DTMF packet format.

### FIELD

The present disclosure relates generally to the conversion of DTMF carrying IP packets in an IP network, and in one example, converting an in-band voice DTMF packet to an out-of-band DTMF packet or an in-band DTMF packet or vice versa.

### BACKGROUND

Dual-tone multi-frequency (DTMF) signaling was developed and is used in various telephone communications networks as a signaling or communication method. For example, DTMF signaling is used in telephone central offices, various branch exchanges and various other applications. In some of the first applications where DTMF dialing signals were used to dial numbers (e.g., telephone numbers), DTMF tones were carried on the voice-frequency band, thereby establishing a form of in-band voice signaling.

Due to certain problems associated with in-band voice DTMF signaling, at least two other methods or protocols for using DTMF signaling have been developed. Out-of-band DTMF communication uses a separate band or a separate dedicated channel, e.g., the signaling path, for the exchange of call control or DTMF information. DTMF in-band signaling uses encapsulation, with the DTMF signal being sent as part of the voice-frequency band. Although the DTMF signal is carried in the voice-frequency band, a different identifier or payload is used during encapsulation, which differentiates this packet from a voice packet, e.g. in-band DTMF. DTMF in-band signaling may also be called a “Named Telephony Event” (NTE) packet (in accordance with RFC 2833) due to the varying identifiers.

Although the majority of new Voice-Over-IP (VoIP) devices, e.g., endpoints and gateways, support NTE (or in-band DTMF) and out-of-band (OOB) formats for DTMF signaling, a fair amount of devices and networks support only the in-band voice DTMF format. As mentioned, the NTE packets can be identified and distinguished from voice packets by their different negotiated payload, while out-of-band signaling is also easy to identify as it uses the same signaling channel which is also used for call establishment and tear down. However, in-band voice DTMF uses the same payload type as voice packets, which makes this type of packet not easily identifiable.

As different sections of the network may support different types of DTMF signaling formats, a mechanism to convert between the different types of DTMF signaling within an Internet Protocol (IP) network is needed.

### BRIEF DESCRIPTION OF DRAWINGS

The present disclosure is illustrated by way of example and not limitation in the figures of the accompanying drawings, in which like references indicate similar elements and in which:

FIG. 1 shows an example of a system in which a network node connects two Internet Protocol (IP) devices in a Voice over IP (VoIP) network, in accordance with an example embodiment;

FIG. 2 shows an example of the network node of FIG. 1 in the form of an IP-to-IP gateway, in accordance with an example embodiment;

FIG. 3 shows a detailed example embodiment depicting call-flow during interworking of in-band voice DTMF to in-band DTMF (or “RFC2833 DTMF”) in an IP-to-IP gateway, in accordance with an example embodiment;

FIG. 4 shows a diagram indicating the flow of various IP packets between an originating IP network device, a network node and a receiving IP network device, in accordance with an example embodiment

FIGS. 5 and 6 show a detailed signaling level system flow similar to FIG. 4, in accordance with the example embodiment;

FIG. 7 shows a flow diagram of an example method for converting DTMF carrying IP packets from one DTMF format to another DTMF format, in accordance with an example embodiment;

FIG. 8 shows a detailed flow diagram of an example method for converting DTMF carrying IP packets from one DTMF format to another DTMF format, in accordance with an example embodiment; and

FIG. 9 shows a diagrammatic representation of machine in the example form of a computer system within which a set of instructions, for causing the machine to perform any one or more of the methodologies discussed herein, may be executed.

### DESCRIPTION OF EXAMPLE EMBODIMENTS

In the following description, for purposes of explanation, numerous specific details are set forth in order to provide a thorough understanding of an embodiment of the present invention. It will be evident, however, to one skilled in the art that the present invention may be practiced without these specific details.

### Overview

A method is described for converting DTMF packets at a network node in an IP network. The method may comprise receiving an Internet Protocol (IP) packet at the network node connected via a first IP network link to a first network device, and connected via a second IP network link to a second network device. The method may determine a first DTMF packet format for the first IP network link and a second DTMF packet format for the second IP network link and detect that only one of the first or second DTMF packet formats is in-band voice DTMF. Thereafter, the method may convert the received IP packet from the first DTMF packet format to the second DTMF packet format.

### Example Embodiments

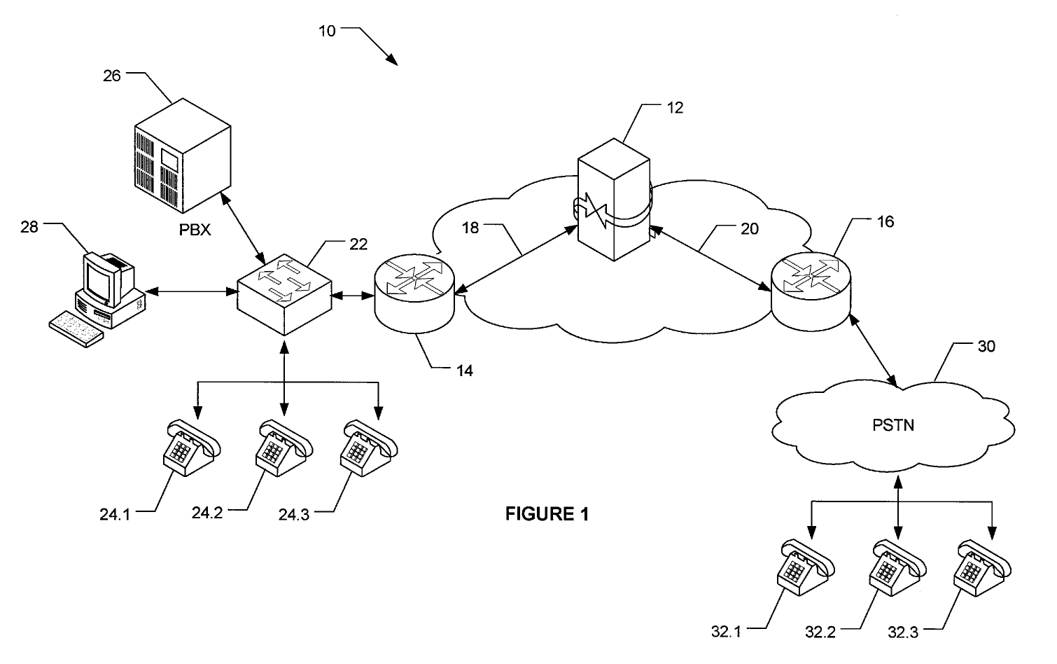

Referring to FIG. 1, reference numeral 10 generally indicates a system, in accordance with an example embodiment, in which a network node 12 connects an originating Internet Protocol (IP) network device 14 and a receiving IP network device 16 in a Voice over IP (VoIP) network.

In an example embodiment, the network node 12 may connect the originating IP network device 14 and the receiving IP network device 16 via first and second network links 18 and 20. The first or second network links 18 and 20 may, for example, be a call leg, and may be either an IP trunk or an IP line, depending on the type of device to which the network link is connected.

In an example embodiment where the first and second network links 18 and 20 are IP trunks, the network node 12 may be an IP-to-IP gateway, while the originating and receiving IP devices 14 and 16 may be routers, e.g., VoIP routers, or switches. In the example embodiment shown in FIG. 1, the network node 12 is an IP-to-IP gateway, the first and second network links 18 and 20 are IP trunks and the originating and receiving IP devices 14 and 16 are VoIP routers, e.g. gateways.

In another example embodiment, the network node 12 may be another IP device, e.g., routers such as Cisco Call Manager (CCM) routers or Cisco Call Manager Express (CME) routers that connect IP telephones via an IP line with an IP trunk.

It will be appreciated that an IP telephone may also be directly coupled to either the originating or receiving IP devices 14 and 16, in which case the network link would be a call line.

As shown in FIG. 1, the originating IP network device 14 may be connected to an IP switch 22 that enables a service provider to migrate end customers, e.g., IP telephones 24.1 to 24.3, Private Branch Exchange (PBX) 26 and one or more personal computers (PCs) 28, from a time-division multiplexing (TDM) based voice service to call agent-based packet voice services.

The receiving IP network device 16 is shown by way of example to be connected to a public switched telephone network (PSTN) 30, which may in turn be connected to telephones 32.1 to 32.3, thereby forming a VoIP network. Other types of telephone endpoints may also be connected to the IP network device 16.

It will be appreciated that various VoIP protocols may be used between the IP switch 22, the originating IP network device 14, the network node 12, and the receiving IP network device 16. The choice of VoIP protocols may depend on the services that need to be delivered over the system 10. For example, on the first and second network links 18 and 20 any one of the following VoIP protocols may be used: H.323, MGCP, and Signal Initiation Protocol (SIP).

Different codecs (coder-decoder), e.g., G.711, G.711 a/u or G.729, may also be used on the different network links. The network node 12 may be configured to handle and convert the different codecs. For example, the network node may have a digital signal processor in the form of a transcoder to manage the different codecs of data received.

In communication networks, such as the VoIP network of FIG. 1, DTMF signaling was developed to allow dialing signals to dial numbers (e.g., telephone numbers) over wire links and non-wire links. A typical DTMF keypad that is used for dialing numbers comprises a 4×4 matrix, with each row of the matrix representing a low frequency (e.g., 697 Hz, 770 Hz, 852 Hz and 941 Hz), while each column of the matrix represents a high frequency (e.g. 1209 Hz, 1336 Hz, 1477 Hz and 1633 Hz). When pressing a single key, e.g., “2”, a single sinusoidal tone of the frequencies 697 Hz and 1336 Hz is generated, with the signal having two tones with different frequencies. These tones may be transmitted over the VoIP network to establish a call, e.g., dialing a number, or in response to a connection to an Interactive Voice Response (IVR) system. The tones may be decoded at a receiving station, e.g., receiving IP network device 16, thereby to determine which key was pressed.

As mentioned, different DTMF formats may be used during communication over IP network links. A first DTMF format may be in-band voice DTMF, which uses voice-frequency bands to transmit a DTMF tone.

A second DTMF format may be out-of-band DTMF, which uses a separate band or a separate dedicated channel, e.g., the signaling path, for the exchange of call control information. For example, the VoIP protocol H.323 provides for two types of out-of-band DTMF signaling, namely H.245 alpha-numeric and H.245 signal. The VoIP protocol SIP may also use an out-of-band DTMF, namely “Notify” and KPML.

A third DTMF format may be in-band DTMF signaling, which uses encapsulation with various different identifiers or payloads. This enables the DTMF signal to be sent as part of the voice-frequency band, but being identifiable as a DTMF carrying IP packet from its identifier or payload. This DTMF format may also be called “Named Telephony Event” (NTE) (in accordance with RFC 2833) due to the varying identifiers or payloads that may be used to identify the type of data being transmitted. Alternatively, this DTMF format may also be called “RFC2833 DTMF”.

In the example embodiment of FIG. 1, a user of an IP telephone 24.1 may call a user of a telephone 32.3. The IP switch 22 may route the call to the originating IP network device 14 which, in turn, may request a call session to the receiving IP network device 16 via the IP-to-IP gateway 12, thereby to establish a call between the IP telephone 24.1 and the telephone 32.3. Depending on the configuration of the VoIP network, the first IP network link 18 and the second IP network link 20 may support different DTMF packet formats. For example, the first IP network link 18 may support in-band voice DTMF, while the second IP network link 20 may support either in-band DTMF (NTE) or alternatively out-of-band DTMF. In a different configuration the first IP network link 18 may support either in-band DTMF (NTE) or out-of-band DTMF, while the second IP network link 20 may support in-band voice DTMF. In these examples, the network node 12 (e.g., an IP-to-IP gateway) converts a DTMF carrying IP packet received over the first IP network link 18 from the DTMF packet format of the first IP network link 18 and the originating IP network device 12, to the DTMF packet format of the second IP network link 20 and the receiving IP network device 16.

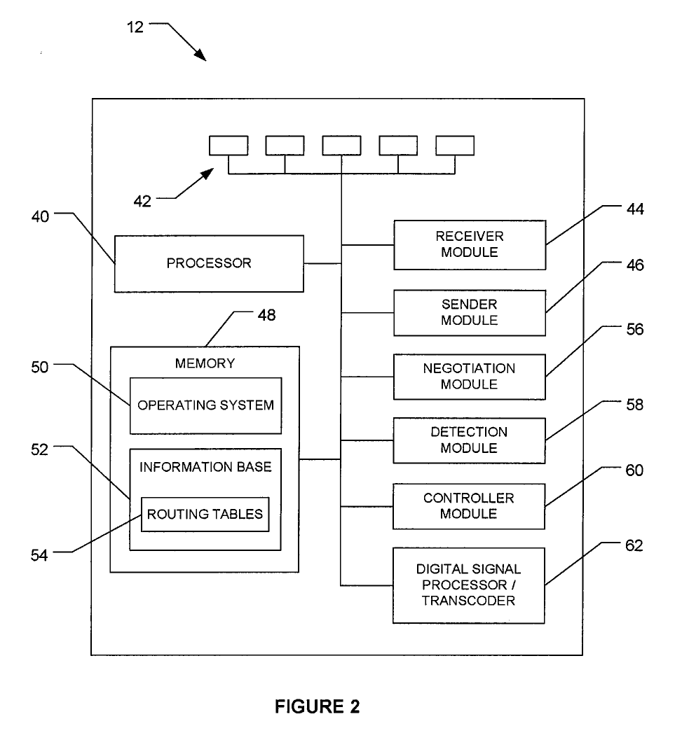

As mentioned, in an example embodiment, the IP network node 12 is an IP-to-IP gateway. An example of this IP-to-IP gateway is now described with reference to the example embodiment of FIG. 2. However, it will be appreciated by persons skilled in the art that the description of FIG. 2 may similarly apply to other network nodes, e.g., IP routers such as Cisco Call Manager (CCM) routers or Cisco Call Manager Express (CME) routers.

The network node 12 may comprise at least one processor 40 connected to a plurality of interfaces 42 that receive and transmit, via a receiver module 44 and a sender module 46, various IP data packets as part of data flows. The plurality of interfaces 42 may be joined by an interconnect fabric (not shown) such as, e.g., a crossbar interconnection switch or high-speed bus.

The processor 40 may have a dedicated memory 48. The memory 48 may comprise storage locations addressable by the processor 40 for storing software programs and data structures to support the operation of the IP network node 12. The processor 40 may also comprise processing elements or logic for executing the software programs and manipulating the data structures.

An operating system 50, portions of which may be resident in the memory 48 and executed by the processor 40, may functionally organize the network node 12 by, inter alia, invoking network operations in support of software processes executing on the processor 40. These software processes may include, inter alia, an information base 52 that may maintain various routing tables 54 to enable the routing of data packets across the network. Underlying topology-gathering protocols may be used to populate the routing tables 54 of the information base 52 thereby to establish and maintain paths or routes.

When one of the end customers, e.g., any one of the IP telephones 24.1 to 24.3, the PBX 26 and the personal computer (PC) 28 in FIG. 1, on the originating end of the VoIP network (e.g., customers connected to the originating IP network device 14) wants to establish a call to one of the end customers on the terminating or receiving end of the VoIP network, e.g., any one of the telephones 32.1 to 32.3, a connection request may be sent from the originating IP network device 14 to the IP network node 12, thereby requesting a connection to be established between the originating IP network device 14 and the receiving IP network device 16 over the first and the second IP network links 18 and 20.

The format of the connection request may be dependent on the protocol of the originating IP network device 14 and the network link 18. For example, in the event that H.323 is the protocol used on the network link 18, the connection request may be a setup message which is sent to initiate a H.323 call or to establish a connection with an H.323 terminal on the IP network node 12. The H.323 setup message may, for example, include the IP address, port and alias of the calling user. Alternatively, in the event that SIP is the protocol used on the network link 18, the connection request may be an invite to invite an end user or a service to a new session.

The receiver module 44 may receive the connection request from a sender module of the originating IP device 14 over the first network link 18. Once a connection is established between the originating IP network device 14 and the receiving IP network device 16, the receiver module 44 may receive a plurality of IP packets from the originating IP network device 14, which packets are transmitted by the sender module of the originating IP device 14. The IP packets may be further transmitted by the sender module 46 to the receiving IP network device 16. As is described in more detail below, certain of the IP packets may be converted to a different DTMF format prior to being transmitted to the receiving IP network device 16 over the second network link 20.

In an example embodiment, the connection request may be the first transmission of handshaking between the different network devices 12, 14 and 16. Handshaking is a sequence of events that may be required for mutual agreement on various protocols and other operational modes between different network devices prior to exchanging information between the network devices.

In an example embodiment, a negotiation module 56 of the network node 12 may perform a capability negotiation with both the originating IP network device 14 and the receiving IP network device 16, thereby to determine a first DTMF packet format for the first IP network link 18 and the originating IP network device 14, as well as to determine a second DTMF packet format for the second IP network link 20 and the receiving IP network device 16.

The capability negotiation may relate to a dial peer in which a codec (coder, decoder), quality of service (QoS), voice activity detection (VAD), and as mentioned, the DTMF format, are defined or determined. For example, during the capability negotiation, the sender module 44 of the network node 12 may transmit a further connection request to the receiving IP network device 16. In response to this connection request, the receiving IP network device 16 may transmit an acknowledgement message including information on the protocols and DTMF format supported by the receiving device 16 and the second network link 20. Once the acknowledgement message is received by the IP network node 12, the network node 12 may transmit a further acknowledgement message to the originating network device 14 to confirm acknowledgement of the original connection request and the associated protocols and DTMF format supported by the originating network device 14 and the first network link 18.

In an example embodiment, the network node 12 may also comprise a detection module 58 that may detect that only one of the first or second DTMF packet formats communicated via the network links 18, 20 may be in-band voice DTMF.

A controller module 60 may, on detection that one of the first or second DTMF packet formats is in-band voice DTMF, insert or activate a digital signal processor (DSP) 62, e.g., a DSP transcoder. The DSP 62 may convert DTMF carrying IP packets, received from the originating IP device 14 and to be transmitted to the receiving IP device 16, from the first DTMF packet format to the second DTMF packet format. For example, the DSP 62 may convert packets from in-band voice DTMF to in-band DTMF or out-of-band DTMF, or vice versa.

The controller module 60 may insert or activate the DSP 62 by programming the DSP 62 for the particular DTMF inter-working identified on the first and second network links 18 and 20. It will be appreciated the DSP need not be inserted, as it may already be activated due to the need for between different codecs which may apply on the first and the second network links 18 and 20. In these circumstances, the DSP 62 may be programmed to manage the particular DTMF inter-working.

For example, once handshaking and capability negotiation have been completed between the originating IP network device 14 and the network node 12, as well as between the network node 12 and the receiving IP network device 16, IP packets, e.g., media packets including voice, may be transmitted from the originating network device 14.

The receiver module 44 of the network node 12 may receive each IP packet and the processor 40 may direct each received IP packet to the DSP 62 for processing. The DSP 62 may process each received IP packet to identify the received IP packet as a DTMF carrying IP packet using the first DTMF packet format.

For example, if the originating network device 14 and first data link 18 use in-band DTMF, the DSP 62 may check the payload of the received IP packet to determine whether the payload indicates that the IP packet is carrying a DTMF tone.

Similarly, if the originating IP network device 14 and first data link 18 use out-of-band DTMF, the DSP 62 may check whether the IP packet is a H.240B alphanumeric or H.235 signal, in the case of H.323 protocol, or whether the IP packet is a SIP notify packet, in the case of SIP protocol. By checking this, the DSP 62 may be able to determine that the IP packet is a DTMF carrying IP packet.

If the originating IP network device 14 and first network link 18 do not specify any DTMF format, the negotiation module 56 may identify an in-band voice DTMF format. In this case, the DSP 62 may check each received IP packet to determine whether the packet carries DTMF. This may be done by standard DTMF tone detection mechanisms. For example, the DSP 62 may reproduce the voice stream contained in the IP packet to determine from the frequency of this voice stream whether a DTMF tone is present or not.

Once it has been determined that the received IP packet carries a DTMF tone, the DSP 62 may convert the received IP packet from the first DTMF packet format to the second DTMF packet format.

In a simplified system 10, the network node 12 may be configured to know the DTMF format of a particular network link. The negotiation module 56 and detection module 58 need not in these circumstances rely on capability negotiation, but may determine the first DTMF packet format for the first IP network link and the second DTMF packet format for the second IP link, as well as detecting that only one of the first or second DTMF packet formats is in-band voice DTMF, from other sources.

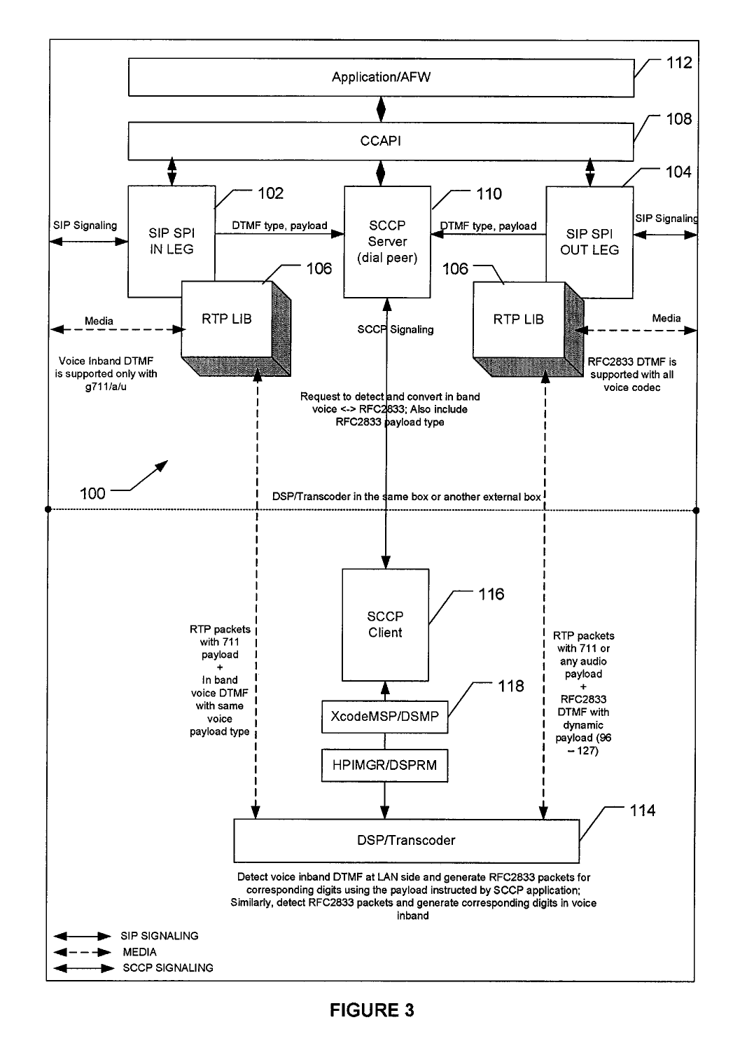

FIG. 3 shows a detailed example embodiment depicting a call-flow during interworking of in-band voice DTMF to in-band DTMF (or “RFC2833 DTMF”) in an IP-to-IP gateway, e.g., a SIP-SIP gateway 100. It follows that, in this example embodiment, SIP is used as the VoIP protocol on both the network links 18 and 20. However, it will be appreciated that H323-H323 or SIP-H323 may also have been the VoIP configuration on the first and second network links 18 and 20.

The SIP-SIP gateway 100 may comprise a SIP service provider interface (SPI), having an SIP SPI in-leg 102 and a SIP SPI out-leg 104. The in-leg 102 may be associated with the first network link 18 and the out-leg 104 may be associated with the second network link 20 of FIG. 1. The SIP-SIP gateway 100 may further comprise a Real-time Transport Protocol Library 106, Call Control API CCAPI 108, a SCCP (Signaling Connection and Control Part) server 110 which may include a dial peer, and a application 112. A digital signal processor/transcoder 114, similar to the DSP/transcoder 62 in FIG. 1, may either form part of the SIP-SIP gateway or may be associated with it.

In one example embodiment, the SIP SPI in-leg 102 and out-leg 104 may be configured to function as the receiver module 44 and sender module 46 as described in with FIG. 2. The SCCP server 110 may be configured to function as the negotiation module 56 and the detection module 58. Communication between the SIP SPI in-leg 102 and the SIP SPI out-leg 104 may occur as described below in accordance with one example embodiment.

A SIP-SIP call may be established, with in-band voice DTMF on the side of the SIP SPI in-leg 102 and RFC2833 DTMF on the side of the SIP SPI out-leg 104. In order to detect in-band voice DTMF, the in-leg 102 may have only a codec of G.711a/u. The out-leg 104 may have any type of audio codec.

For all G.711a/u calls, the CCAPI 108 (which may be configured to function as the controller module 60 of FIG. 2) may request the SCCP server 110 for a DSP/Transcoding resource, e.g., DSP/Transcoder 114. In order to support the interworking between in-band & RFC2833 DTMF, the DSP/Transcoder may be invoked, even though the codecs on the in-leg 102 and out-leg 104 may be different.

The CCAPI 108 may transfer an in-band DTMF to RFC2833 DTMF conversion request to the SCCP server 110 along with the payload to be used for RFC2833 DTMF. This DTMF conversion request is in addition to information that may be sent otherwise, e.g., codec and bytes. In turn, the SCCP server 110 may transfer this request and information on to a SCCP client 116 which may be, but need not be, a separate device. This information is passed on to a DSP Farm 118. The DSP Farm 118 may comprise an array of DSPs which can be used for multiple purposes including transcoding, transrating, DTMF detection and conversions. The DSP 114 may detect in-band voice DTMF on the G.711 SIP SPI in-leg 102 and to generate the RFC2833 DTMF digits with the given payload type.

It will be appreciated that the functionality will be similar if a call was to be converted from the out-leg 104 to the in-leg 102, in that the DSP 114 is then to detect RFC2833 DTMF and generate in-band voice DTMF on G.711.

As mentioned above, the IP-to-IP gateway in existing systems may invoke the DSP 114 only when codec on each leg is different. However, to implement the mechanism of converting DTMF carrying packets, the DSP 114 may also be invoked if one leg has in-band voice DTMF with G.711a/u and the other leg has RFC2833 DTMF (or e.g., out-of-band DTMF), irrespective of codec on the legs. Existing out-of-band to RFC2833 DTMF support may be provided in both transcoder and non-transcoder calls. For in-band voice DTMF to RFC2833 DTMF conversion, the RTP library 106 need not detect RFC2833 DTMF packets. Also, and as mentioned, the SCCP server 110 may receive the DTMF type and its payload and pass it down to SCCP client 116.

Certain limitations may apply to the example embodiment of FIG. 3, in that the call leg which negotiates in-band voice DTMF should use G.711a/u, while the other leg (e.g., the peer leg) with RFC2833 DTMF may have any IP-to-IP gateway supported audio codec. Also, if the DSP 114 is not a separate device, there may be two more RTP sessions for the DSP 114. The SCCP messages may be between SCCP server 110 and SCCP application 116, whether the DSP 114 is a separate device or not.

Further to the example embodiment of FIG. 3, a new function may be defined to determine whether a transcoding resource (e.g. the DSP 114) should be reserved or not. This function may check the DTMF type of the both of the call legs (e.g., the network links 18 and 20) on the network node 12, e.g., an IP-to-IP gateway. The new function, as set out by way of example below, relates particularly to SIP and in-band voice DTMF to in-band DTMF (e.g., RTP-NTE or “RFC2833 DTMF”):

```
boolean sipSPI_g711_inband_to_rtp_nte(ccsipCCB_t *ccb,
                ccChannelInfo_t *channelInfo);
    {
      ...........
      /* If one side of the dial-peer is configured as G. 711 and in-band
      * voice DTMF, AND the other side of the dial-peer is configured
      * as, RTP-NTE DTMF, then return TRUE otherwise return
      FALSE.
      ........
      }
```

The following functions may be defined to query the DTMF info:

```
ccsip_query_dtmf_info(ccCallID_t called, ulong *dtmf)
{
    /* This function is used to query the dtmf info
    */
    .........
}
```

A registry may be defined and a “reg_invoke” may be inserted for both the SIP and H323 protocol, as CCAPI needs the DTMF information from both the H323 and SIP SPIs.

reg_invoke_cc_spi_query_dtmf_info( ).

At the CCAPI level, the following new function may be introduced to obtain the DTMF information:

```
ccGetCurrentDtmf(ccCallID_t callID, ulong *dtmfMask)
  {
    /* this function is used to get the dtmf info and pass it the ccapi level.
    */
      ......
    return reg_invoke_cc_spi_query_dtmf_info().
  }
```

The following example skinny function may be extended by the insertion of a “ulong dtmf_method” command to take one more parameter:
void skinny_xcode_associate_stream(int stream, ccVdbPtr_t srcIF, ccCallID_t srcID, ccVdbPtr_t dstIF, ccCallID_t dstID, int codes, int bytes, boolean vad, void *context, ulong dtmf_method)

This function may pass the “dtmf_method” to the skinnyXcodeStream structure, and then to station messages.

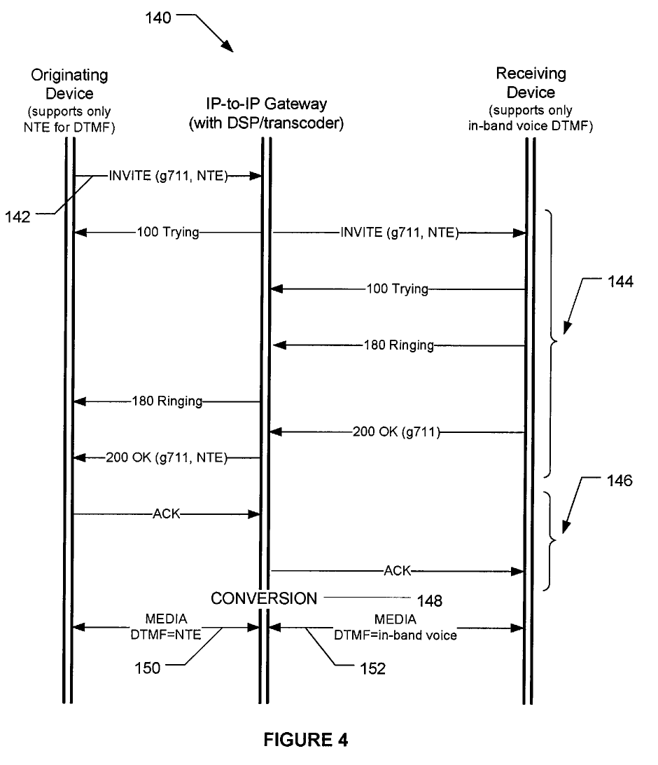

FIG. 4 shows a simplified diagram 140 indicating the flow of various IP packets between an originating IP network device 14, a network node 12 and a receiving IP network device 16, in accordance with an example embodiment, where SIP is used as the VoIP protocol. In this example embodiment the originating IP network device 14 may support only in-band DTMF or NTE, while the receiving IP network device 16 may support only in-band voice DTMF. The network node 12, which may be an IP-to-IP gateway, comprises a DSP 62 as described above with reference to FIG. 2.

As shown by reference numeral 142, a connection request in the form of an Invite may be sent from the originating network device 14 to the network node 12. Arrow 144 shows all the operations of capability negotiation performed between the originating IP network device 14, the network node 12 and the receiving IP network device 16. At the end of the capability negotiation, the network node 12 may detect a mismatch in the DTMF formats supported by the originating IP network device 14 and the receiving IP network device 16. When such a mismatch is detected, the DSP 62 of the network node 12 may be inserted or activated to modify one or more DTMF formats. The ACK (see arrow 146) completes the SIP session/dialog of a given call. It also confirms that offer and answer have been successfully exchanged.

After the acknowledgement packets are received, IP data packets are transmitted from the originating IP network device 14 to the network node 12 (shown by arrow 148) are converted. In particular, DTMF carrying IP packets in the first DTMF format are converted to the DTMF format in a second format corresponding to the receiving network device 16 (shown by arrow 150). For example, the network node 12 may convert DTMF carrying IP packets from in-band DTMF (NTE) packets to the in-band voice DTMF IP packets. The network node 12 then transmits the converted IP data packets on to the receiving network device 16 (shown by arrow 152). Thus, DTMF format conversion may be performed at an IP level.

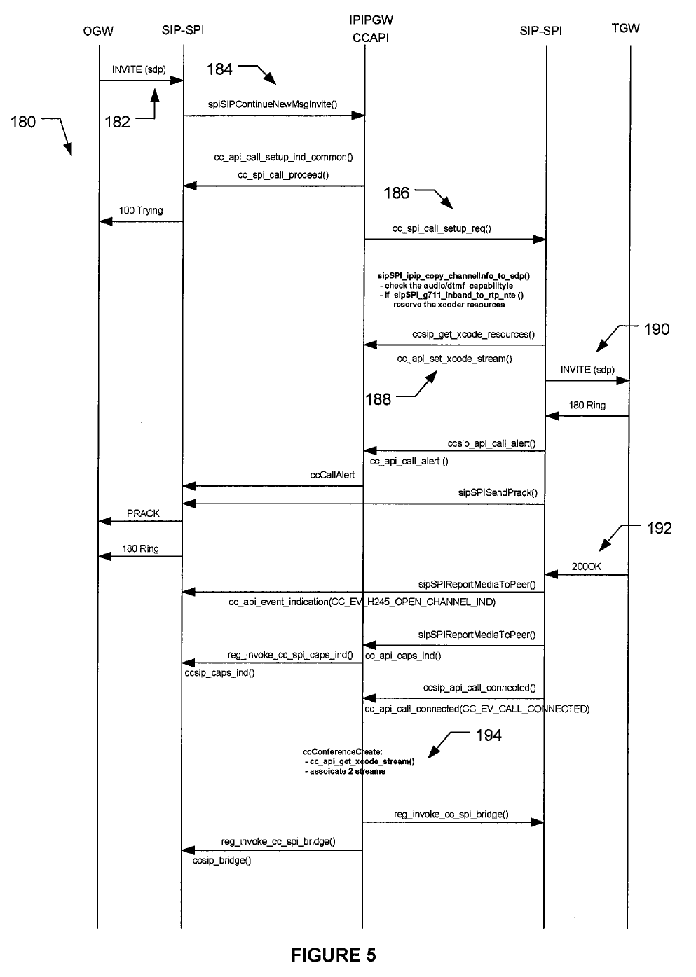

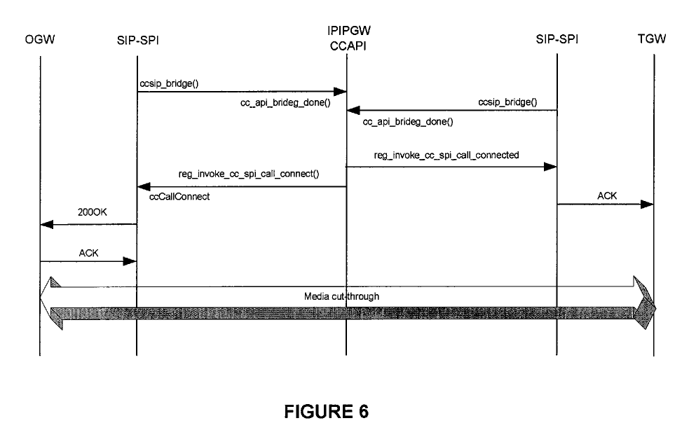

FIGS. 5 and 6 show an example detailed signaling level system flow 180 of the example embodiment of FIG. 3. The system flow 180 shows an example embodiment where the SIP-SIP gateway 100 of FIG. 3 converts in-band voice DTMF to in-band DTMF (RTP-NTE or “RFC2833 DTMF”).

A SIP originating gateway is shown to send an Invite (shown by arrow 182) with SDP (Session Description Protocol) to the SIP-SIP gateway 100. The SIP-SIP gateway 100 may now read the media information from the SDP (shown by arrow 184), and may find that the received DTMF type matches with the DTMF type configured on the in-leg 102 of the dial-peer. The SIP-SIP gateway 100 may pass the in-leg media information to the out-leg via a Veena event (shown by arrow 186). In sipSPI_ipip_copy_channelInfo_to_SDP( ), a new function sipSPI_g711_inband_to_rtp_nte( ) (as described above) may be called to check whether DTMF transcoding is needed or not. If a “TRUE” value is returned (shown by arrow 188), transcoding resources (e.g., the DSP 114) may be allocated to perform the transcoding.

The SIP-SIP gateway 100 may send an Invite (shown by arrow 190) with SDP to a SIP terminating gateway and may receive 200OK (shown by arrow 192) with SDP. The SIP-SIP gateway 100 may determine that the received DTMF type matches the DTMF type on the out-leg dial-peer and the call may then proceed. It will be appreciated that, if the received DTMF type is different from the DTMF type configured on the dial-peer, the whole DTMF negotiation may fail and no DTMF between the call will be established.

During the ccConferenceCreate( ) (shown by arrow 194), CCAPI 108 may check for the DTMF type on both the call legs, and if one side is G.711 with DTMF in-band, and the other side is RTP-NTE DTMF, the CCAPI 108 may invoke the DSP/transcoder and bridge streams.

The following is an example of the transcoding resource configuration, in accordance with the example embodiment of FIG. 3:

```
sccp ccm group 123
  associate ccm 1 priority 1
  associate profile 1 register mtp000cce5d3cd0
  keepalive retries 5
  switchover method immediate
  switchback method immediate
  switchback interval 15
!
dspfarm profile 1 transcode
  codec g711ulaw
  codec g711alaw
  codec g729ar8
  codec g729abr8
  codec gsmfr
  maximum sessions 5
  associate application SCCP
!
telephony-service
  load 7960-7940 P00303020209
  max-ephones 24
  max-dn 48
  ip source-address 1.7.56.116 port 2000
  sdspfarm units 2
  sdspfarm transcode sessions 128
  sdspfarm tag 1 mtp000cce5d3cd0
  create cnf-files version-stamp Jan. 01 2002 00:00:00
  max-conferences 8 gain −6
  call-forward pattern ....
  moh flash:lavenderskies1min.au
  web admin system name cisco password cisco
  transfer-system full-consult
  transfer-pattern ....
  log password abcd
  xmltest
```

The following is a sample configuration for a G.711 in-band voice DTMF to in-band DTMF (RFC2833 or NTE)

```
dial-peer voice 1111 voip
  description - Incoming dial-peer
  incoming called-number .T
  codec g711ulaw
dial-peer voice 2222 voip
  description - Outgoing dial-peer
  destination-pattern .T
  session target ipv4: 10.10.1.1
  dtmf-relay rtp-nte
```

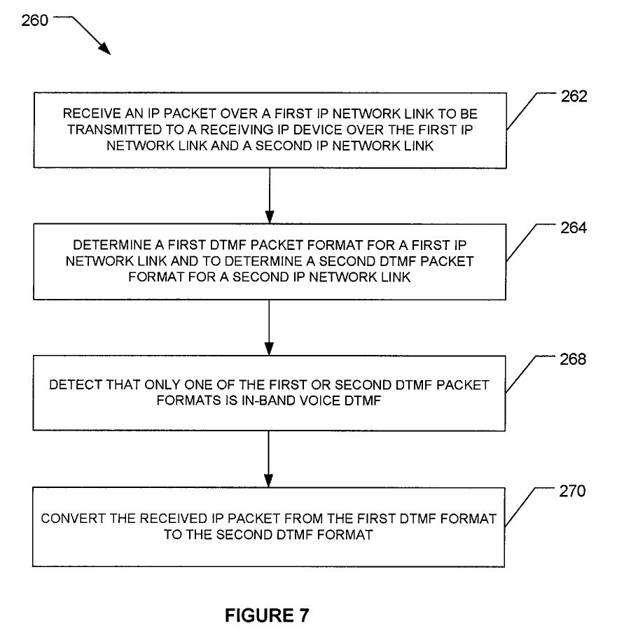

FIG. 7 shows a flow diagram of a method 260, in accordance with an example embodiment, for converting DTMF carrying IP packets between different DTMF formats. In one example embodiment, the method 260 may be implemented in a VoIP network as shown by FIG. 1, e.g., by the IP network node 12 which may be configured as an IP-to-IP gateway or a router.

As shown by block 262, the network node 12 may receive an IP packet over a first IP network link 18, the IP packet to be transmitted from the originating IP device 14 to a receiving IP device 16 over the first IP network link 18 and the second IP network link 20. This operation may be, but need not be, preceded by a capability negotiation that is described in more detail below. The DTMF related IP packets sent over the first IP network link 18 may be required in a first DTMF packet format, and the DTMF related IP packets sent over the second network link 20 may be required in a second DTMF format. In an example embodiment, the method 260 may detect that only one of a first or second DTMF packet format is in-band voice DTMF and convert the received IP packet from the first DTMF packet format to the second DTMF packet format.

Thus, a negotiation module 56 may determine, as shown by block 264, a first DTMF packet format for the first IP network link 18 and determine a second DTMF packet format for the second IP network link 20. The negotiation module 56 may determine the DTMF packet formats during a capability negotiation or may, alternatively, obtain this information from other sources in circumstances where the network device 12 has been preconfigured.

In an example embodiment, a detection module 58 may detect that only one of the first or second DTMF packet formats is in-band voice DTMF (shown by block 266). When the detection module 58 detects that DTMF packet format conversion is required, the DSP 62 may be inserted to perform the conversion.

As shown by block 268, a DSP 62 may convert DTMF related IP packets received from the originating IP network device 14 for transmission to the receiving IP network device 16 from the first DTMF packet format to the second DTMF packet format. Accordingly, in an example embodiment DTMF detection may be performed at an IP side of the network.

The other of the first or second DTMF packet formats may be, in example embodiments, either in-band DTMF or out-of-band DTMF.

The functionality described above may be preceded by a connection request from the originating IP network device 14 to the receiving IP network device 16. As mentioned above, the connection request may differ in format depending on the underlying protocol of the network link 18. For example, the connection request may be a setup message which is sent to initiate a H.323 call or may be a SIP invite (see for example FIG. 5). Capability negotiation may be performed by the negotiation module 56 to determine the first DTMF packet format for the first IP network link 18 and to determine the second DTMF packet format for the second IP network link 20. As discussed above, the capability negotiation may relate to handshaking and a dial peer in which various parameters of the network protocols are defined, amongst other things, the DTMF packet format supported by the network links 18 and 20.

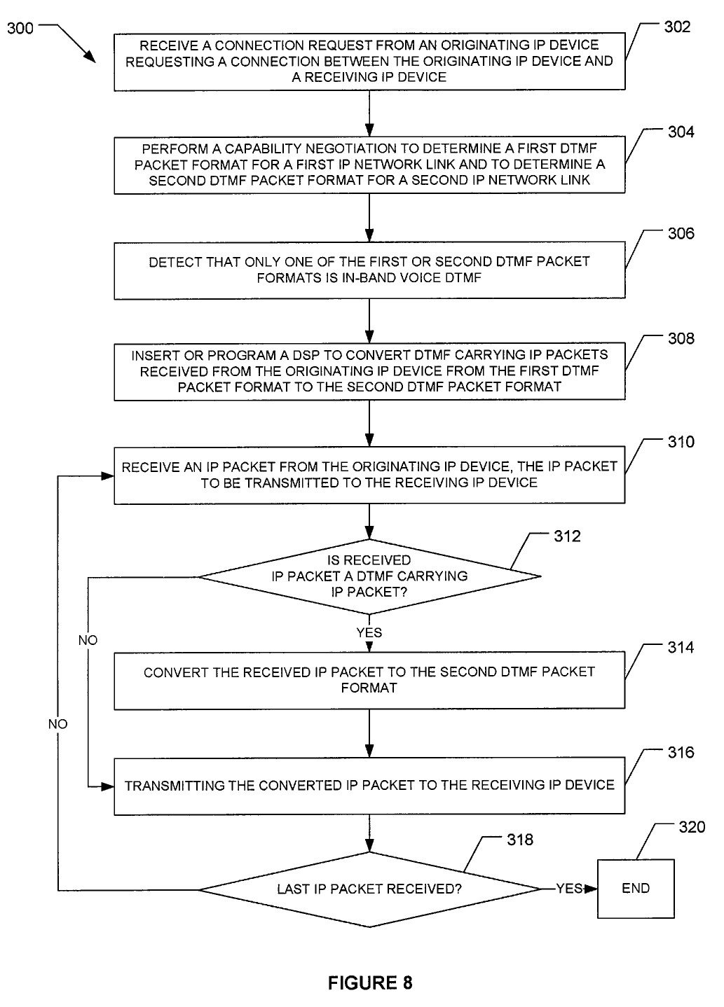

FIG. 8 shows a flow diagram of a more detailed example of a method 300 for converting DTMF carrying IP packets between different DTMF formats. As this example embodiment is an extension of the example embodiment of FIG. 7, the method 300 may also be implemented in a VoIP network as shown by FIG. 1, e.g., by the network node 12 which may be configured as an IP-to-IP gateway or a router.

As shown by block 302, the network node 12 may receive a connection request from an originating IP network device 14 over a first IP network link 18, the connection request requesting a connection between the originating IP network device 14 and the receiving IP network device 16 over the first and second IP network links 18 and 20. As mentioned, the connection request may differ in format depending on the underlying protocol of the network link 18. For example, the connection request may be a setup message which is sent to initiate a H.323 call or may be a SIP invite.

The negotiation module 56 may perform a capability negotiation (shown by block 304) to determine a first DTMF packet format for the first IP network link 18 and to determine a second DTMF packet format for the second IP network link 20. As discussed above, the capability negotiation may relate to handshaking and a dial peer in which various parameters of the network protocols are defined, amongst other things the DTMF packet format supported by the network links 18 and 20.

The detection module 58 may detect that only one of the first or second DTMF packet formats is in-band voice DTMF (shown by block 306). As shown by block 308, the controller module 60 may now insert or activate a digital signal processor (DSP) 62 to convert DTMF carrying IP packets received from the originating IP network device 14 for transmission to the receiving IP network device 16 from the first DTMF packet format to the second DTMF packet format. The DSP 62 may be activated or inserted (see block 308) by programming the DSP to perform the particular DTMF interworking. In an example embodiment multiple DSPs/transcoders may be provided in a DSP farm.

As mentioned above, the other of the first or second DTMF packet formats may, in example embodiments, be either in-band DTMF or out-of-band DTMF.

Once the controller module 60 has inserted, activated and/or programmed the DSP 62 and once the negotiation request has been acknowledged by the IP network node 12, IP data packets may be transmitted from the sender module 46 of the originating IP network device 14. The receiver module 44 of the network node 12 may receive this IP packet for transmission to the receiving network device 16 (shown by block 310).

As shown by decision block 312, the DSP 62 may now determine whether the received IP packet is a DTMF carrying IP packet which uses the first DTMF packet format. As discussed above, various methods may be used for this determination. For example, the DSP 62 may check the payload of the received IP packet to determine whether the payload indicates that the IP packet is carrying a DTMF tone. The DSP 62 may also check whether the IP packet is a particular signaling packet (e.g., H.240B alphanumeric or H.235 signal in the case of H.323 protocol, or SIP Notify in the case of SIP protocol) to determine whether a received IP packet having an out-of-band DTMF format is carrying DTMF signal. Alternatively, the DSP 62 may check each received IP packet by using DTMF tone detection mechanisms to determine whether the IP packet carries in-band voice DTMF signal.

In the event that the IP packet is a DTMF carrying IP packet which uses the first DTMF packet format, the DSP transcoder 62 may convert the received IP packet from the first DTMF packet format to the second DTMF packet format, as shown by block 314. The converted IP packet may now be transmitted, as shown by block 316, by the sender module 46 to the receiving IP network device 16.

In the event that the IP packet is not a DTMF carrying IP packet, the DSP 62 may forward the IP packet to the sender module 46 which may transmit the IP packet without any conversion to the receiving IP network device 16 (shown by block 316).

Once the IP packet has been transmitted, the network node 12 may check whether the received IP packet was the last to be transmitted to the receiving IP network device 16 (shown by decision block 318) and if this is the case, the transmission will end (shown by block 320).

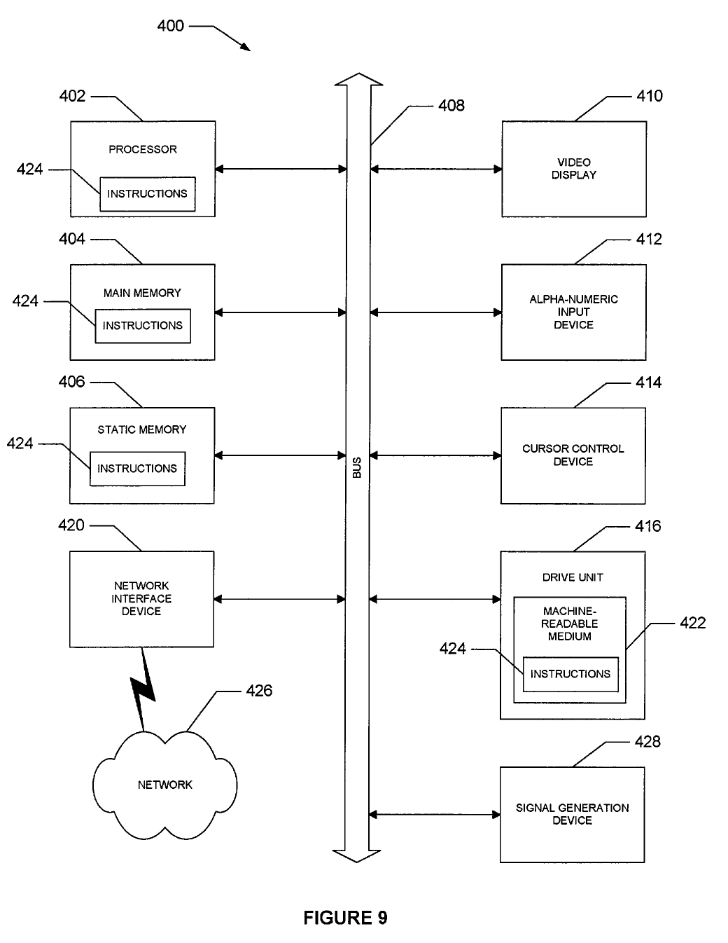

FIG. 9 shows a diagrammatic representation of machine in the example form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a plasma display, a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420 utilizing any one of a number of well-known transfer protocols (e.g., HTTP).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving an Internet Protocol (IP) packet at a network node connected via a first IP network link to a first network device, and connected via a second IP network link to a second network device;
determining a first DTMF packet format for the first IP network link and a second DTMF packet format for the second IP network link;
detecting that only one of the first or second DTMF packet formats is in-band voice DTMF; and
converting the received IP packet from the first DTMF packet format to the second DTMF packet format.

2. The method of claim 1, wherein the first DTMF packet format is in-band voice DTMF and the second DTMF packet format is out-of-band DTMF.

3. The method of claim 1, wherein the first DTMF packet format is in-band voice DTMF and the second DTMF packet format is a Named Telephony Event (NTE) packet in accordance with RFC 2833.

4. The method of claim 1, wherein the converting is performed on an IP-side of the network node and the converted IP packet is thereafter transmitted to the second network device.

5. The method of claim 1, further comprising, prior to receiving the IP packet, receiving a connection request over the first IP network link from the first network device, the connection request requesting a connection between the first network device and the second network device over the first IP network link and the second IP network link.

6. The method of claim 1, wherein determining the first DTMF packet format the second DTMF packet format is performed during a capability negotiation.

7. The method of claim 1, comprising configuring a digital signal processor to convert DTMF carrying IP packets received from the first network device from the first DTMF packet format to the second DTMF packet format.

8. The method of claim 7, further comprising, prior to configuring the digital signal processor, inserting the digital signal processor in a transmission path at the network node.

9. The method of claim 1, wherein detecting that only one of the first or second DTMF packet formats is in-band voice DTMF comprises inspecting a payload type of the received IP packet.

10. The method of claim 1, which is executed at an IP level in a router, a switch, an IP-to-IP gateway, or a Voice over IP (VoIP) call manager.

11. An apparatus comprising:
a receiver module to receive an Internet Protocol (IP) packet, the apparatus connectable via a first IP network link to a first network device, and connectable via a second IP network link to a second network device;
a negotiation module to determine a first DTMF packet format for the first IP network link and a second DTMF packet format for the second IP network link;
a detection module to detect that only one of the first or second DTMF packet formats is in-band voice DTMF; and
a processor to convert the received IP packet from the first DTMF packet format to the second DTMF packet format.

12. The apparatus of claim 11, wherein the first DTMF packet format is in-band voice DTMF and the second DTMF packet format is out-of-band DTMF.

13. The apparatus of claim 11, wherein the first DTMF packet format is in-band voice DTMF and the second DTMF packet format is a Named Telephony Event (NTE) packet in accordance with RFC 2833.

14. The apparatus of claim 11, wherein the conversion is to be performed on an IP-side of the apparatus and the converted IP packet is thereafter to be transmitted to the second network device.

15. The apparatus of claim 11, further comprising a receiver module that is configured to receive a connection request over the first IP network link from the first network device, wherein the connection request is to request a connection between the first network device and the second network device over the first IP network link and the second IP network link.

16. The apparatus of claim 11, wherein determining the first DTMF packet format the second DTMF packet format is performed during a capability negotiation.

17. The apparatus of claim 11, comprising a controller module to configure a digital signal processor to convert DTMF carrying IP packets received from the first network device from the first DTMF packet format to the second DTMF packet format.

18. The apparatus of claim 17, wherein the controller is configured to insert the digital signal processor in a transmission path at the network node.

19. The apparatus of claim 11, wherein the detection module is configured to inspect a payload type of the received IP packet to detect that only one of the first or second DTMF packet formats is in-band voice DTMF.

20. The apparatus of claim 11, which is configured to function as a router, a switch, an IP-to-IP gateway, or a Voice over IP (VoIP) call manager.

21. An apparatus comprising:
means for receiving an Internet Protocol (IP) packet at a network node connected via a first IP network link to a first network device, and connected via a second IP network link to a second network device;
means for determining a first DTMF packet format for the first IP network link and a second DTMF packet format for the second IP network link;
means for detecting that only one of the first or second DTMF packet formats is in-band voice DTMF; and
means for converting the received IP packet from the first DTMF packet format to the second DTMF packet format.
